(19) United States
(12) Patent Application Publication
(10) Pub. No.: US 2026/0003193 A1
(43) Pub. Date: Jan. 1, 2026

(54) Display Device with Compact Projectors

(71) Applicant: Apple Inc., Cupertino, CA (US)

(72) Inventors: Christopher M. Scannell, San Francisco, CA (US); Cameron A. Harder, San Francisco, CA (US)

(21) Appl. No.: 19/237,637

(22) Filed: Jun. 13, 2025

Related U.S. Application Data
(60) Provisional application No. 63/666,014, filed on Jun. 28, 2024.

(51) Int. Cl. G02B 27/01

(52) U.S. Cl. CPC G02B 27/0172; G02B 2027/0178

(57) ABSTRACT

A head-mounted device may have a nose bridge that joins a first and second waveguides. The first and second waveguides may overlap respective eye boxes. The device may include display projectors in the nose bridge. The display projectors may include display panels that emit image light. The nose bridge may include optics that direct the image light to the first and second waveguides. Optical couplers on the first and second waveguides may couple the image light into the first and second waveguides and may couple the image light out of the first and second waveguides and towards the eye boxes. The optics in the nose bridge may include scanning mirrors, additional waveguides, and/or a binocularly combined freeform prism.

This application claims the benefit of U.S. Provisional Patent Application No. 63/666,014, filed Jun. 28, 2024, which is hereby incorporated by reference herein in its entirety.

### FIELD

This relates generally to electronic devices, including electronic devices such as head-mounted devices.

### BACKGROUND

Electronic devices can include displays that provide images near the eyes of a user. Such electronic devices often include virtual or augmented reality headsets with displays having optical elements that allow users to view the displays. If care is not taken, components used to display images can be bulky or might not exhibit desired levels of optical performance.

### SUMMARY

A head-mounted device such as a pair of glasses may have a head-mounted housing. The housing may have a nose bridge that joins a left waveguide to a right waveguide. The left waveguide may overlap a left eye box. The right waveguide may overlap a right eye box. A user may wear the device on their head. The user's left eye may overlap the left eye box and the user's right eye may overlap the right eye box while wearing the device. The device may include a left display projector and a right display projector that are both mounted within the nose bridge. The left and right display projectors may include display panels that emit image light. Optics in the nose bridge may direct the image light to the left and right waveguides. Optical couplers may couple the image light into the waveguides and may couple the image light out of the waveguides and towards the eye boxes.

In some implementations, the optics in the nose bridge may include scanning mirrors. The scanning mirrors may scan the image light over different portions of the fields of view of the left and right eye boxes. In some implementations, the optics in the nose bridge may include additional waveguides that direct the image light from the display panels to the left and right waveguides. The display panels and optical couplers on the additional waveguides may be wavelength multiplexed or may be wavelength specific. Wavelength specific optical couplers and display panels may be linearly or radially arranged in the nose bridge. In some implementations, the optics in the nose bridge may include a binocularly combined freeform prism that directs image light from both projectors to the left and right waveguides.

### BRIEF DESCRIPTION OF THE DRAWINGS

FIG. 1 is a diagram of an illustrative system in accordance with some embodiments.

FIG. 2 is a top view of an illustrative head-mounted device in accordance with some embodiments.

FIG. 3 is a top view of an illustrative head-mounted device that includes a nose bridge display projector that provides image light to a waveguide in accordance with some embodiments.

FIG. 4 is a top view of an illustrative nose bridge display projector that includes a scanning mirror in accordance with some embodiments.

FIG. 5 is a diagram showing how a scanning mirror in an illustrative nose bridge display projector may sequentially display different portions of a field of view in accordance with some embodiments.

FIG. 6 is a top view of an illustrative nose bridge display projector that includes a waveguide in accordance with some embodiments.

FIG. 7 is a front view of an illustrative nose bridge display projector having colinear display panels in accordance with some embodiments.

FIG. 8 is a front view of an illustrative nose bridge display projector having non-colinear display panels in accordance with some embodiments.

FIG. 9 is a rear view of an illustrative waveguide for a nose bridge display projector having colinear output couplers in accordance with some embodiments.

FIG. 10 is a rear view of an illustrative waveguide for a nose bridge display projector having non-colinear output couplers in accordance with some embodiments.

FIG. 11 is a top view of an illustrative prism that may be used to redirect light from nose bridge display projectors to left and right waveguides in a head-mounted device in accordance with some embodiments.

### DETAILED DESCRIPTION

An electronic device such as a head-mounted device may be provided with a head-mounted housing. The housing may have a nose bridge that joins a first waveguide to a second waveguide. The first waveguide may overlap a first eye box. The second waveguide may overlap a second eye box. To help maximize binocular alignment between the eye boxes over the operating life of the device, the device may include first and second display projectors within the nose bridge. The first and second projectors may include display panels that emit image light for the first and second eye boxes respectively. The nose bridge may include optics that direct the image light to the first and second waveguides. Optical couplers on the first and second waveguides may couple the image light into the waveguides and may couple the image light out of the waveguides and towards the eye boxes.

To minimize the size of the nose bridge without sacrificing optical performance, the optics in the nose bridge may include scanning mirrors. The scanning mirrors may scan the image light over different portions of the fields of view of the eye boxes. If desired, the optics in the nose bridge may include additional waveguides that direct the image light from the display panels to the waveguides. The display panels and optical couplers on the additional waveguides may be wavelength multiplexed or may be wavelength specific. Wavelength specific optical couplers and display panels may be linearly or radially arranged in the nose bridge. If desired, the optics in the nose bridge may include a binocularly combined freeform prism that directs image light from both projectors to the left and right waveguides.

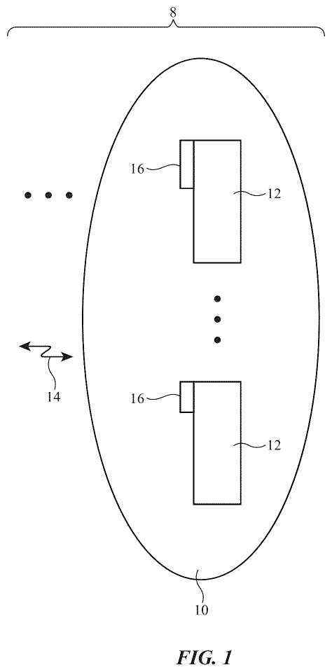

FIG. 1 is a schematic diagram of an illustrative system that may include one or more electronic devices. As shown in FIG. 1, system 8 may include electronic devices 10. Devices 10 may include head-mounted devices (e.g., goggles, glasses, helmets, and/or other head-mounted devices), cellular telephones, tablet computers, peripheral devices such as headphones, game controllers, and/or other input devices. Devices 10 may, if desired, include laptop computers, computer monitors containing embedded computers, desktop computers, media players, or other handheld or portable electronic devices, smaller devices such as wristwatch devices, pendant devices, ear buds, or other wearable or miniature devices, televisions, computer displays that do not contain embedded computers, gaming devices, remote controls, embedded systems such as systems in which equipment is mounted in a kiosk, in an automobile, airplane, or other vehicle, removable external cases for electronic equipment, straps, wrist bands or head bands, removable covers for electronic devices, cases or bags that receive and carry electronic equipment and other items, necklaces or arm bands, wallets, sleeves, pockets, or other structures into which electronic equipment or other items may be inserted, part of an item of clothing or other wearable item (e.g., a hat, belt, wrist band, headband, sock, glove, shirt, pants, etc.), or equipment that implements the functionality of two or more of these devices.

With one illustrative configuration, which may sometimes be described herein as an example, system 8 includes a head-mounted device such as a pair of glasses (sometimes referred to as augmented reality glasses). System 8 may also include peripherals such as headphones, game controllers, and/or other input-output devices (as examples). In some scenarios, system 8 may include one or more stand-alone devices 10. In other scenarios, multiple devices 10 in system 8 exchange information using wired and/or wireless links, which allows these devices 10 to be used together. For example, a first of devices 10 may gather user input or other input that is used to control a second of devices 10 (e.g., the first device may be a controller for the second device). As another example, a first of devices 10 may gather input that is used in controlling a second device 10 that, in turn, displays content on a third device 10.

Devices 10 may include components 12. Components 12 may include control circuitry. The control circuitry may include storage and processing circuitry for supporting the operation of system 8. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in the control circuitry may be used to gather input from sensors and other input devices and may be used to control output devices. The processing circuitry may include one or more processors such as microprocessors, microcontrollers, digital signal processors, baseband processors and other wireless communications circuits, power management units, audio chips, application specific integrated circuits, etc.

To support communications between devices 10 and/or to support communications between equipment in system 8 and external electronic equipment, devices 10 may include wired and/or wireless communications circuitry. The communications circuitry of devices 10, which may sometimes be referred to as control circuitry and/or control and communications circuitry, may include antennas, radio-frequency transceiver circuitry, and other wireless communications circuitry and/or wired communications circuitry. The communications circuitry of devices 10 may, for example, support bidirectional wireless communications between devices 10 over wireless links such as wireless link 14 (e.g., a wireless local area network link, a near-field communications link, a wireless personal area network link, a Bluetooth® link, a Wi-Fi® link, a cellular telephone link, a device-to-device (D2D) link, a 60 GHz link or other centimeter/millimeter wave link, a sub-THz link, etc.). Components 12 may also include power circuits for transmitting and/or receiving wired and/or wireless power and may include batteries.

Components 12 may include input-output devices. The input-output devices may be used in gathering user input, in gathering information on the environment surrounding the user, and/or in providing a user with output. The input-output devices may include sensors such as force sensors (e.g., strain gauges, capacitive force sensors, resistive force sensors, etc.), audio sensors such as microphones, touch and/or proximity sensors such as capacitive sensors, optical sensors such as optical sensors that emit and detect light, ultrasonic sensors, and/or other touch sensors and/or proximity sensors, monochromatic and color ambient light sensors, image sensors, sensors for detecting position, orientation, and/or motion (e.g., accelerometers, magnetic sensors such as compass sensors, gyroscopes, and/or inertial measurement units that contain some or all of these sensors), radio-frequency sensors, depth sensors (e.g., structured light sensors and/or depth sensors based on stereo imaging devices), optical sensors such as self-mixing sensors and light detection and ranging (lidar) sensors that gather time-of-flight measurements, humidity sensors, moisture sensors, and/or other sensors. In some arrangements, devices 10 may use sensors and/or other input-output devices to gather user input (e.g., buttons may be used to gather button press input, touch sensors overlapping displays can be used for gathering user touch screen input, touch pads may be used in gathering touch input, microphones may be used for gathering audio input, accelerometers may be used in monitoring when a finger contacts an input surface and may therefore be used to gather finger press input, etc.). Components 12 may include haptic output devices. The haptic output devices can produce motion that is sensed by the user (e.g., through the user's head, hands, or other body parts). Haptic output devices may include actuators such as electromagnetic actuators, motors, piezoelectric actuators, electroactive polymer actuators, vibrators, linear actuators, rotational actuators, actuators that bend bendable members, etc.

If desired, input-output devices in components 12 may include other devices such as displays (e.g., to display images for a user), status indicator lights (e.g., a light-emitting diode that serves as a power indicator, and other light-based output devices), speakers and other audio output devices, electromagnets, permanent magnets, structures formed from magnetic material (e.g., iron bars or other ferromagnetic members that are attracted to magnets such as electromagnets and/or permanent magnets), etc.

As shown in FIG. 1, sensors such as position sensors 16 may be mounted to one or more of components 12. Position sensors 16 may include accelerometers, magnetic sensors such as compass sensors, gyroscopes, and/or inertial measurement units (IMUs) that contain some or all of these sensors. Position sensors 16 may be used to measure location (e.g., location along X, Y, and Z axes), orientation (e.g., angular orientation around the X, Y, and Z axes), and/or motion (changes in location and/or orientation as a function of time). Sensors such as position sensors 16 that can measure location, orientation, and/or motion may sometimes be referred to herein as position sensors, motion sensors, and/or orientation sensors.

Devices 10 may use position sensors 16 to monitor the position (e.g., location, orientation, motion, etc.) of devices 10 in real time. This information may be used in controlling one or more devices 10 in system 8. As an example, a user may use a first of devices 10 as a controller. By changing the position of the first device, the user may control a second of devices 10 (or a third of devices 10 that operates in conjunction with a second of devices 10). As an example, a first device may be used as a game controller that supplies user commands to a second device that is displaying an interactive game.

Devices 10 may also use position sensors 16 to detect any changes in position of components 12 with respect to the housings and other structures of devices 10 and/or with respect to each other. For example, a given one of devices 10 may use a first position sensor 16 to measure the position of a first of components 12, may use a second position sensor 16 to measure the position of a second of components 12, and may use a third position sensor 16 to measure the position of a third of components 12. By comparing the measured positions of the first, second, and third components (and/or by using additional sensor data), device 10 can determine whether calibration operations should be performed, how calibration operations should be performed, and/or when/how other operations in device 10 should be performed.

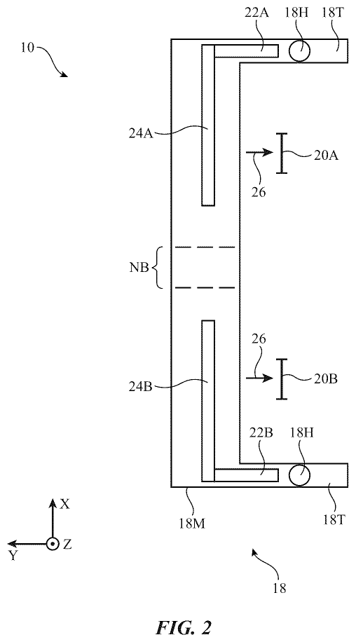

In an illustrative configuration, devices 10 include a head-mounted device such as a pair of glasses (sometimes referred to as augmented reality glasses). A top view of device 10 in an illustrative configuration in which device 10 is a pair of glasses is shown in FIG. 2. A shown in FIG. 2, device 10 may include housing 18. Housing 18 may include a main portion (sometimes referred to as a glasses frame) such as main portion 18M and temples 18T that are coupled to main portion 18M by hinges 18H. Main portion 18M may include a nose bridge portion such as nose bridge portion NB. Nose bridge portion NB may have a recess that allows main portion 18M of housing 18 to rest on a nose of a user while temples 18T rest on the user's ears.

Images may be displayed in eye boxes 20 using displays 22 and waveguides 24. Displays 22 may sometimes be referred to herein as projectors 22, projector displays 22, display projectors 22, light projectors 22, image projectors 22, light engines 22, or display modules 22. Projectors 22 may include a first projector 22B (sometimes referred to herein as left projector 22B) and a second projector 22A (sometimes referred to herein as right projector 22A). Projectors 22A and 22B may be mounted at opposing right and left edges of main portion 18M of housing 18, for example.

Eye boxes 20 may include a first eye box 20B (sometimes referred to herein as left eye box 20B) and may include a second eye box 20A (sometimes referred to herein as right eye box 20A). Waveguides 24 may include a first waveguide 24B (sometimes referred to herein as left waveguide 24B) and a second waveguide 24A (sometimes referred to herein as right waveguide 24A). Main portion 18M of housing 18 may, for example, have a first portion that includes first projector 22B and first waveguide 24B and a second portion that includes second projector 22A and second waveguide 24A (e.g., where nose bridge NB separates the first and second portions such that the first portion is at a first side of the nose bridge and the second portion is at a second side of the nose bridge).

Waveguides 24 may have input couplers that receive light from projectors 22. This image light is then guided laterally (along the X axis) within waveguides 24 in accordance with the principal of total internal reflection (TIR). Each waveguide 24 may have an output coupler in front of a respective eye box 20. The output coupler couples the image light out of the waveguide 24 and directs an image towards the associated eye box 20 for viewing by a user (e.g., a user whose eyes are located in eye boxes 20), as shown by arrows 26. Input and output couplers for device 10 may be formed from diffractive gratings (e.g., surface relief gratings, volume holograms, etc.) and/or other optical structures.

For example, as shown in FIG. 2, first projector 22B may emit (e.g., produce, generate, project, or display) image light that is coupled into first waveguide 24B (e.g., by a first input coupler on first waveguide 24B). The image light may propagate in the +X direction along first waveguide 24B via total internal reflection. The output coupler on first waveguide 24B may couple the image light out of first waveguide 24B and towards first eye box 20B (e.g., for view by the user's left eye at first eye box 20B). Similarly, second projector 22A may emit (e.g., produce, generate, project, or display) image light that is coupled into second waveguide 24A (e.g., by a second input coupler on second waveguide 24A). The image light may propagate in the −X direction along second waveguide 24A via total internal reflection. The output coupler on second waveguide 24A may couple the image light out of second waveguide 24A and towards second eye box 20A (e.g., for view by the viewer's right eye at second eye box 20A).

Waveguides 24 may each include one or more stacked substrates (e.g., stacked planar and/or curved layers sometimes referred to herein as waveguide substrates) of optically transparent material such as plastic, polymer, glass, etc. If desired, waveguides 24 may also include one or more layers of holographic recording media (sometimes referred to herein as holographic media, grating media, or diffraction grating media) on which one or more diffractive gratings are recorded (e.g., holographic phase gratings, sometimes referred to herein as holograms).

A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating media may include photopolymers, gelatin such as dichromated gelatin, silver halides, holographic polymer dispersed liquid crystal, or other suitable holographic media.

Diffractive gratings on waveguides 24 may include holographic phase gratings such as volume holograms or thin-film holograms, meta-gratings, or any other desired diffractive grating structures. The diffractive gratings on waveguides 24 may also include surface relief gratings (SRGs) formed on one or more surfaces of the substrates in waveguides 24, gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Surface relief gratings are formed from modulations in the thickness of an SRG medium (e.g., where the SRG includes ridges and troughs in the SRG medium that form fringes of the SRG). Volume holograms are formed from modulations in the refractive index in the volume of a grating medium (e.g., where lines of constant refractive index form fringes of the volume holograms).

The example of FIG. 2 in which projectors 22A and 22B are located at the lateral periphery of main portion 18M of housing 18 (e.g., adjacent temples 18T) is illustrative and non-limiting. Placing projectors 22A and 22B at these locations may, for example, require resource-intensive sensing, processing, and/or correction operations to be performed to ensure that images displayed at eye box 20B are binocularly aligned with images displayed at eye box 20A. This is because the left and right edges of main body portion 18M and temples 18T tend to physically move with respect to each other during use and wear of device 10, which can produce substantial binocular misalignment between the images displayed at eye box 20A and the images displayed at eye box 20B.

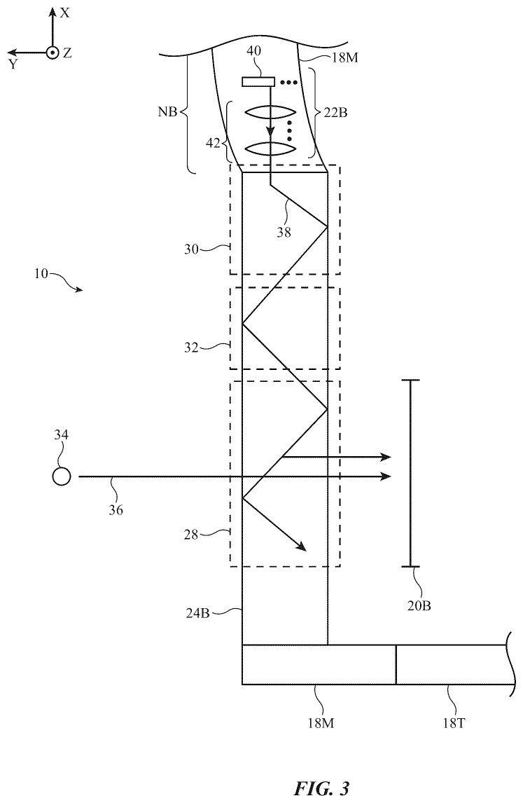

To help mitigate these issues, projectors 22A and 22B may be disposed in nose bridge portion NB of device 10. FIG. 3 is a top view showing one example of how projector 22A may be disposed in nose bridge portion NB of device 10 for providing image light to waveguide 24B. FIG. 3 illustrates the left half of device 10 for the sake of clarity. Projector 22A (FIG. 2) may similarly be mounted in nose bridge portion NB for providing image light to waveguide 24A at the right side of device 10.

As shown in FIG. 3, projector 22B may be mounted to or within nose bridge portion NB of main housing 18M (e.g., main housing 18M may surround and enclose projector 22B within device 10). Projector 22B is sometimes also referred to herein as nose bridge projector 22B or nose bridge display projector 22B. Projector 22B may include one or more display panels 40 and optics 42. Display panel(s) 40 may include one or more arrays of emissive display pixels (e.g., light-emitting diode (LED) pixels, organic LED (OLED) pixels, micro LED (uLED) pixels, etc.) that emit image light 38. Image light 38 may be, for example, light that contains and/or represents something viewable such as a scene or object. Image data (e.g., a series of image frames or images) may be modulated onto image light 38 by the display pixels in display panel(s) 40. The image data may contain images of virtual objects (e.g., image light 38 may carry or convey virtual (computer-generated) objects for display at eye box 20B).

Projector 22B may include a single display panel 40 or more than one display panel 40. In implementations where projector 22B includes a single display panel 40, the display panel may include different sets of pixels that emit each wavelength range of image light 38. For example, display panel 40 may include red, green, and blue pixels disposed in an interleaved array pattern across the display panel. In implementations where projector 22B includes multiple display panels 40, the pixels of each display panel may emit a different respective wavelength range of image light 38. For example, projector 22B may include a first display panel 40 with red pixels that emit red light, a second display panel 40 with green pixels that emit green light, and a third display panel 40 with blue pixels that emit blue light. If desired, projector 22B may include a first display panel with a first set of pixels that emit a first wavelength range of image light 38 and may include a second display panel with both a second set of pixels that emit a second wavelength range and a third set of pixels that emit a third wavelength range of image light 38. In implementations where projector 22B includes more than one display panel 40, optics 42 may, if desired, include an optical combiner, X-cube, prism, diffractive grating, and/or other optics that combine the light emitted by each display panel together to collectively form image light 38.

Optics 42 may include one or more optical elements or components that redirect, focus, refract, diffract, reflect, collimate, and/or otherwise direct or deliver image light 38 from display panel(s) 40 to waveguide 24B. Optics 42 may include, for example, one or more lenses or lens elements, optical wedges, prisms, reflective polarizers, polarizers, mirrors, partially reflective mirrors, louvered mirrors, diffractive gratings, color filters, X-cubes, condensers, wave plates, birefringent elements, polarization rotators, and/or other optical components.

Waveguide 24B may include one or more optical couplers (e.g., light redirecting elements) such as input coupler 30, cross-coupler 32, and output coupler 28. In the example of FIG. 3, input coupler 30, cross-coupler 32, and output coupler 28 are formed at or on waveguide 24B. Input coupler 30, cross-coupler 32, and/or output coupler 28 may be completely embedded within or between the substrate layers of waveguide 24B (e.g., transparent substrate layers, a diffractive grating medium within waveguide 24B, etc.), may be partially embedded within the substrate layers of waveguide 24B, may be mounted to waveguide 24B (e.g., mounted to an exterior surface of waveguide 24B), etc.

Optics 42 may direct image light 30 towards input coupler 30. Input coupler 30 may couple image light 38 into waveguide 24B (e.g., by redirecting image light 38 onto angles that are within a TIR range of the waveguide, within which light propagates down the waveguide via TIR). Waveguide 24B may guide image light 38 down its length towards output coupler 28 via TIR (e.g., in the −X direction). Output coupler 28 may couple image light 38 out of waveguide 24B and towards eye box 20B (e.g., by redirecting image light 38 onto angles that are outside the TIR range of the waveguide).

Input coupler 30 may include an input coupling prism (e.g., a transmissive or reflective input coupling prism), an edge or face of waveguide 32 (e.g., an angled edge of waveguide 24B), a lens, a steering or scanning mirror, a liquid crystal steering element, diffractive grating structures (e.g., volume holograms, SRGs, etc.), partially reflective structures (e.g., louvered mirrors), and/or any other desired input coupling elements.

In implementations where cross-coupler 32 is formed on waveguide 24B, cross-coupler 32 may redirect image light 38 in one or more directions as the light propagates down the length of waveguide 24 (e.g., towards output coupler 28 from a direction of propagation as coupled into the waveguide by the input coupler). This may, for example, help to direct light from input coupler 30 towards output coupler 28 regardless of the lateral locations of input coupler 30 and output coupler 28 on waveguide 24B. When redirecting image light 38, cross-coupler 32 may also perform pupil (image) expansion on image light 38 in one or more directions. In expanding pupils of the image light, cross-coupler 32 may, for example, help to reduce the vertical size of waveguide 24B relative to implementations where cross-coupler 32 is omitted. Cross-coupler 32 may therefore sometimes also be referred to herein as pupil expander 32 or optical expander 32. If desired, output coupler 28 may also expand image light 38 upon coupling the image light out of waveguide 24B (e.g., in a direction orthogonal to the direction of expansion performed by cross-coupler 32).

Input coupler 30, cross-coupler 32, and/or output coupler 28 may be based on reflective and refractive optics or may be based on diffractive (e.g., holographic) optics. In arrangements where couplers 30, 32, and 28 are formed from reflective and refractive optics, couplers 30, 32, and 28 may include one or more reflectors (e.g., an array of micromirrors, partial mirrors, louvered mirrors, or other reflectors). In arrangements where couplers 30, 32, and 28 are based on diffractive optics, couplers 30, 32, and 28 may include diffractive gratings (e.g., volume holograms, surface relief gratings, etc.).

In some implementations that are described herein as an example, input coupler 30, cross-coupler 32, and/or output coupler 28 include volume holograms. Volume holograms in waveguide 24B may be disposed within a grating medium on or within waveguide 24B (not shown in FIG. 3 for the sake of clarity). Each volume hologram may be recorded within its grating medium as a respective modulation in the refractive index n of the grating medium (e.g., where planes of constant refractive index in the grating medium form the fringes of the hologram). The volume holograms may be recorded using two interfering recording beams of light (e.g., a signal beam and a reference beam) in a holographic recording (writing) apparatus during the manufacture of device 10. The interference pattern of the beams of light is recorded as a modulation in refractive index n of the grating medium. Once the interference pattern has been recorded in the grating medium, the grating medium may be developed (cured) using curing light. Once cured, no further volume holograms can be recorded or written in the grating medium.

Each volume hologram may be defined or characterized by a corresponding grating vector k (e.g., in momentum space or k-space). Grating vector k has a magnitude |k| (sometimes also referred to as a grating frequency, which sometimes also denoted using a capital letter K). The magnitude of grating vector k corresponds to the wavelength of light diffracted by that volume hologram (e.g., a wavelength at which light is Bragg-matched to the volume hologram). The grating frequency is also related to the spacing between the lines of constant index. The direction of grating vector k is orthogonal to the lines of constant refractive index in the volume hologram. The direction of grating vector k is also related to the incident angle and the output/diffracted angle with which the volume hologram diffracts light (e.g., the direction of grating vector k determines the incident and output/diffracted angles of the volume hologram that satisfy its Bragg matching condition). In other words, the direction of grating vector k identifies the incident angle of light that is diffracted by the volume hologram as well as the corresponding output (diffracted) angle that the light is diffracted onto. The volume hologram may diffract light from an incident angle onto an output angle but also conversely diffracts light incident from the output angle onto the incident angle.

Multiple volume holograms may be superimposed or multiplexed within the same volume of a corresponding grating medium. Put differently, at a given point within the volume of the grating medium, there may be one or more superimposed volume holograms formed from corresponding refractive index modulations that are superimposed onto each other at that point of the grating medium. As modulated, the refractive index may sometimes be referred to herein as modulated refractive index dn (e.g., a refractive index that varies spatially across the area of the grating medium). The multiplexed volume holograms may have different grating frequencies (grating vector magnitudes) for diffracting a range of different wavelengths of light and/or different orientations (grating vector directions) for diffracting light from a range of incident angles onto a corresponding range of output angles. Additionally or alternatively, the multiplexed volume holograms may, if desired, perform expansion on the diffracted light (e.g., by collectively diffracting light from a single incident angle onto a range of different output angles).

The example of FIG. 3 is illustrative and non-limiting. If desired, device 10 may include multiple waveguides 24B that are laterally and/or vertically stacked with respect to each other. Each waveguide 24B may include one, two, all, or none of couplers 30, 32, and 28. Waveguide 24B may be at least partially curved or bent if desired. Cross-coupler 32 may be omitted if desired. In other implementations, waveguide 24B may include a single optical coupler that performs the operations of two or more of input coupler 30, cross-coupler 32, and output coupler 28 (e.g., an interleaved coupler, a diamond coupler, or a diamond expander).

The operation of waveguide 24B on image light 38 is shown in FIG. 2. Image light 38 contains visible light of one or more visible wavelength ranges (e.g., red, green, and blue wavelength ranges). Waveguide 24B may also be used to direct infrared or near-infrared light from infrared emitter(s) towards eye box 20B and to direct reflected infrared or near-infrared light from eye box 20B towards IR sensor(s) in device 10 (e.g., for performing gaze tracking).

If desired, output coupler 28 may form an optical combiner that allows real-world light 36 (sometimes referred to herein as world light 36, external light 36, scene light 36, or ambient light 36) produced by and/or reflected off real-world objects 34 (sometimes referred to herein as external objects 34) to be combined optically with virtual (computer-generated) images such as virtual images in image light 38. In this type of system, which is sometimes referred to as an augmented reality (AR) system, a user of device 10 may view both real-world content and computer-generated content that is overlaid on top of the real-world content. Camera-based augmented reality systems may also be used in device 10 (e.g., in an arrangement in which a camera captures real-world images of external objects and this content is digitally merged with virtual content for display at eye box 20B).

In practice, there may be very little space within nose bridge portion NB of main housing portion 18M to accommodate the components of projector 22B. On one hand, it would be desirable for display panel(s) 40 to be as small as possible so display panel(s) 40 can fit within nose bridge portion NB while still allowing device 10 to be comfortable for the user to wear. On the other hand, it may be desirable for display panel(s) 40 to be as large as possible to maximize the resolution of the images in image light 38 and the size of the field of view (FOV) of the image light 38 as received at eye box 20B.

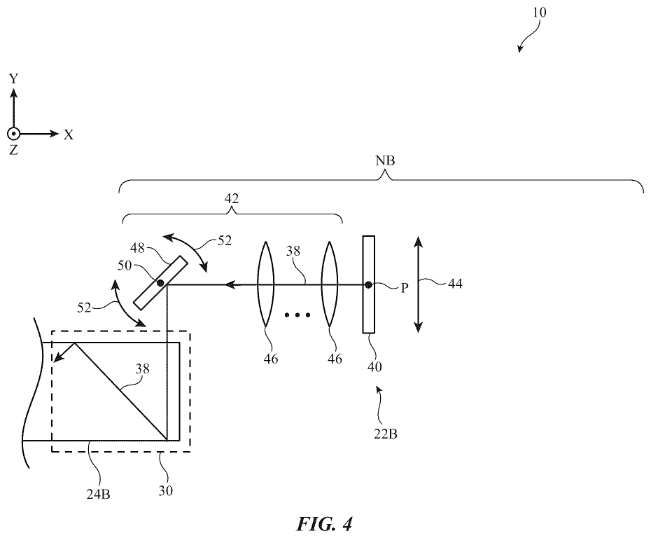

To mitigate these issues (e.g., minimizing the size of projector 22B without sacrificing the size of the FOV of image light 38), the optics 42 in projector 22B may include a scanning mirror that reflects image light 38 from display panel(s) 40 towards input coupler 30. FIG. 4 is a top interior view showing one example of how the optics 42 in projector 22B may include a scanning mirror. Main portion 18M of housing 18 is omitted from FIG. 4 for the sake of clarity.

As shown in FIG. 4, optics 42 may include one or more lens elements 46 (e.g., collimating lenses sometimes also referred to herein as eyepiece optics or eyepiece lenses). Display panel(s) 40 may include an array of pixels P that emit image light 38 towards lens element(s) 46 (a single ray of which is illustrated in FIG. 4 for the sake of clarity). The optical axis of display panel(s) 40 and lens element(s) 46 may be parallel to a propagation direction of image light via TIR in waveguide 24B. Optics 42 may also include a scanning mirror such as scanning mirror 48. Scanning mirror 48 may be electrically adjustable between two or more positions, angles, or orientations. For example, as shown by arrows 52, scanning mirror 48 may be electrically controlled (e.g., using a control signal generated by control circuitry) to rotate between two or more positions, angles, or orientations about rotational axis 50. Scanning mirror 48 may be a microelectromechanical systems (MEMS) mirror or a piezoelectric mirror, for example. Scanning mirror 48 is sometimes also referred to herein as adjustable mirror 48, rotatable mirror 48, electrically adjustable mirror 48, electromechanical mirror 48, rotating mirror 48, or sweeping mirror 48. If desired, optics 42 may include additional components (e.g., optical wedges, prisms, lenses, reflectors, etc.) that are optically coupled between scanning mirror 48 and input coupler 30.

Lens element(s) 46 may direct image light 38 onto scanning mirror 48. Scanning mirror 48 may reflect image light 38 towards input coupler 30. Input coupler 30 may couple image light 38 into waveguide 24B for propagation towards output coupler 28 and eye box 20B (FIG. 3). Scanning mirror 48 may cycle between two or more orientations, each corresponding to a different respective portion, subset, region, area, or angle range of the overall FOV of image light 38 and eye box 20B. Put differently, at each orientation, scanning mirror 48 may direct image light 38 towards a different respective portion of the FOV.

Display panel 40 may be synchronized with scanning mirror 48 to provide images of virtual content within each different respective portion of the FOV while scanning mirror 48 is at the corresponding orientation. By cycling through orientations of scanning mirror 48 and portions of the FOV more rapidly than the response time of the human eye, the user may perceive the image light 38 provided to eye box 20B as seamlessly filling the entire FOV. This may allow the size (e.g., width) of display panel(s) 40 to be reduced to a size 44 that corresponds to the size of each respective portion of the FOV, which is much smaller than the size required for display panel 40 to fill the entire FOV of eye box 20B in the absence of scanning mirror 48.

If desired, scanning mirror 48 may have a baseline orientation (angle) that is calibrated in factory or in the field (e.g., to correct for optical misalignments in device 10 at the time of manufacture or throughout its operating life). If desired, the orientation of scanning mirror 48 may also be updated over time based on gaze tracking data captured by device 10 (e.g., to apply a dynamic vergence correction to virtual content in image light 38). Since both the projector 22B for the left eye box 20B and the projector 22A for the right eye box 20A (FIG. 2) are disposed in nose bridge portion NB of device 10, both projectors coexist in the same rigidly bound reference frame, which may help to prevent binocular misalignment between the left and right eye boxes over time.

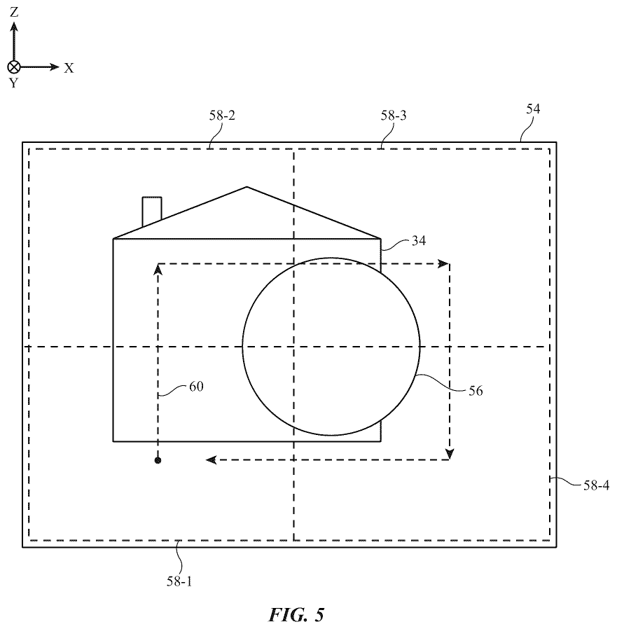

FIG. 5 is a diagram of an exemplary FOV 54 at eye box 20B. As shown in FIG. 5, real-world objects 34 may be visible within FOV 54 (e.g., in real-world light 36 transmitted to eye box 20B by output coupler 28 of FIG. 3). Projector 20B may generate image light 38 that contains computer-generated content such as virtual object 56. Output coupler 28 (FIG. 3) may overlay virtual object 56 with real-world objects 34.

In the example of FIG. 5, scanning mirror 48 cycles (rotates) between four orientations (angles) for each frame of image data to be displayed by projector 22B. Display panel(s) 40 may emit a respective portion of the frame of image data while scanning mirror 48 is at each of the four orientations. By rapidly scanning through the four orientations and for portions of the frame of image data (e.g., as shown by arrow 60), the entirety of FOV 54 may be filled with image light and image light may collectively appear to the user as a single continuous frame displayed across all of FOV 54.

For example, as shown in FIG. 5, scanning mirror 48 may be at a first orientation at a first time. While at the first orientation, scanning mirror 48 may reflect image light 38 towards input coupler 30 (FIG. 4) at an angle such that the image light reaches eye box 20B within a first portion 58-1 of FOV 54. At the first time, display panel(s) 40 may emit a first portion of virtual object 56 (e.g., the portion of virtual object 56 within portion 58-1 of FOV 54).

Scanning mirror 48 may then rotate to a second orientation at a second time. While at the second orientation, scanning mirror 48 may reflect image light 38 towards input coupler 30 at an angle such that the image light reaches eye box 20B within a second portion 58-2 of FOV 54. At the second time, display panel(s) 40 may emit a second portion of virtual object 56 (e.g., the portion of virtual object 56 within portion 58-2 of FOV 54).

Scanning mirror 48 may then rotate to a third orientation at a third time. While at the third orientation, scanning mirror 48 may reflect image light 38 towards input coupler 30 at an angle such that the image light reaches eye box 20B within a third portion 58-3 of FOV 54. At the third time, display panel(s) 40 may emit a third portion of virtual object 56 (e.g., the portion of virtual object 56 within portion 58-3 of FOV 54).

Scanning mirror 48 may then rotate to a fourth orientation at a fourth time. While at the fourth orientation, scanning mirror 48 may reflect image light 38 towards input coupler 30 at an angle such that the image light reaches eye box 20B within a fourth portion 58-4 of FOV 54. At the fourth time, display panel(s) 40 may emit a fourth portion of virtual object 56 (e.g., the portion of virtual object 56 within portion 58-4 of FOV 54). By cycling through respective quadrants of FOV 54 in this way (as shown by arrow 60), the entirety of FOV 54 may be filled with image light 38 while allowing display panel(s) 40 to be one-quarter the size that would otherwise be required to fill FOV 54 in the absence of scanning mirror 48.

The example of FIG. 5 is illustrative and non-limiting. In general, FOV 54 may be divided into any desired number of portions 58 (e.g., two portions 58, three portions 58, more than four portions 58) and scanning mirror 48 may be scanned across fewer or more than four orientations. Portions 58 may be scanned in any desired order. Portions 58 may have any desired shape and/or size. Portions 58 are sometimes also referred to herein as subsets 58, regions 58, or sub-regions 58 of FOV 54.

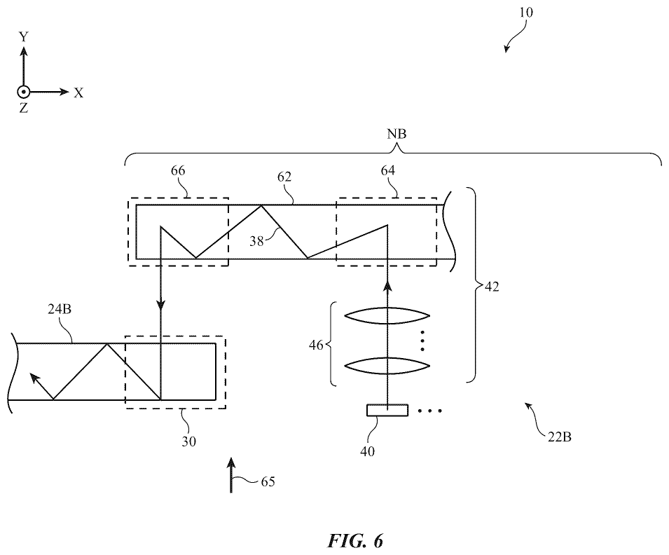

If desired, the optics 42 in nose bridge portion NB may include an additional waveguide used to propagate image light 38 from display panel(s) 40 towards the eye boxes. FIG. 6 is a top interior view showing one example of how optics 42 may include an additional waveguide. Main portion 18M of housing 18 is omitted from FIG. 6 for the sake of clarity.

As shown in FIG. 6, optics 42 may include an additional waveguide such as waveguide 62 optically coupled between lens element(s) 46 and the input coupler 30 on waveguide 24B (e.g., waveguide 62 may be disposed in the optical path between lens element(s) 46 and input coupler 30). Waveguide 62 may include an input coupler 64 and an output coupler 66. Scanning mirror 48 (FIG. 4) may be omitted from optics 42 in implementations where optics 42 include waveguide 62 or may, if desired, be included in optics 42 in implementations where optics 42 include waveguide 62 (e.g., scanning mirror 48 may be optically coupled between lens element(s) 46 and input coupler 64 or between output coupler 66 and input coupler 30).

Input coupler 64 of waveguide 62 may include an input coupling prism (e.g., a transmissive or reflective input coupling prism), an edge or face of waveguide 62 (e.g., an angled edge of waveguide 62), a lens, a steering or scanning mirror (e.g., scanning mirror 48 of FIG. 4), a liquid crystal steering element, diffractive grating structures (e.g., volume holograms, SRGs, etc.), partially reflective structures (e.g., louvered mirrors), and/or any other desired input coupling elements. Output coupler 66 of waveguide 62 may include an edge or face of waveguide 62, a steering or scanning mirror (e.g., scanning mirror 48 of FIG. 4), diffractive grating structures (e.g., volume holograms, SRGs, etc.), partially reflective structures (e.g., louvered mirrors), and/or any other desired input coupling elements.

Lens element(s) 46 may direct image light 38 towards input coupler 64. Input coupler 64 may couple image light 38 into waveguide 62 (e.g., within the TIR range of waveguide 62). Waveguide 62 may propagate image light 38 down its length towards output coupler 66 (e.g., in the −X direction). Output coupler 66 may couple image light 38 out of waveguide 62 and towards input coupler 30 (e.g., by redirecting image light 38 onto angles outside the TIR range of waveguide 62).

Waveguide 62 may include a single input coupler 64 that couples each wavelength range of image light 38 into waveguide 62 (e.g., input coupler 64 may include a broadband SRG, multiplexed holograms that are superimposed with each other and that collectively diffract the different wavelength ranges of image light 38, a louvered mirror, etc.). Alternatively, waveguide 62 may include different respective input couplers 64 that each couple a different respective wavelength range of image light 38 into waveguide 62 (e.g., input coupler 64 may include different regions with different SRGs or hologram sets that diffract different wavelength ranges of image light 38, a louvered mirror where different regions of the louvered mirror are provided with different color filters for reflecting different wavelength ranges of image light 38, slivers of different reflective wavelength-specific reflective coatings, etc.).

Waveguide 62 may include a single output coupler 66 that couples each wavelength range of image light 38 out of waveguide 62 (e.g., output coupler 66 may include a broadband SRG, multiplexed holograms that are superimposed with each other and that collectively diffract the different wavelength ranges of image light 38, a louvered mirror, etc.). Alternatively, waveguide 62 may include different respective output couplers 66 that each couple a different respective wavelength range of image light 38 out of waveguide 62 (e.g., output coupler 66 may include different regions with different SRGs or hologram sets that diffract different wavelength ranges of image light 38, a louvered mirror where different regions of the louvered mirror are provided with different color filters for reflecting different wavelength ranges of image light 38, slivers of different reflective wavelength-specific reflective coatings, etc.). If desired, waveguide 62 may include a cross-coupler optically coupled between input coupler 64 and output coupler 66.

If desired, optics 42 may include a stack of multiple waveguides 62. In these implementations, each waveguide 62 may propagate a different one of the wavelength ranges or a different combination of the wavelength ranges in image light 38 (e.g., the input coupler 64 and output coupler 66 on each waveguide 62 may redirect a different one of the wavelength ranges or a different combination of the wavelength ranges in image light 38). The waveguide(s) 62 in optics 42 may, for example, help to minimize the size and/or footprint of projector 22B. For example, the display panel(s) 40 and lens element(s) 46 in projector 22B may be oriented to face outward (e.g., with an optical axis orthogonal to the direction of propagation of the image light via TIR in waveguide 24B), which may minimize the footprint of the projector in nose bridge portion NB (e.g., helping to narrow the width of nose bridge portion NB).

If desired, the same waveguide 62 (or stack of waveguides 62) may be used to propagate image light from the left projector 22B to the left eye box 20B and to propagate image light from the right projector 22A to the right eye box 20A in device 10 (FIG. 2). In these implementations, waveguide 62 (or a stack of waveguides 62) may include additional input couplers 64 and output couplers 66 for redirecting the light from the right projector 22A towards the right eye box 20A. Alternatively, nose bridge portion NB may include an additional waveguide 62 that directs image light from the right projector 22A to the right eye box 20A (e.g., the components of FIG. 6 may be mirrored at the right side of device 10).

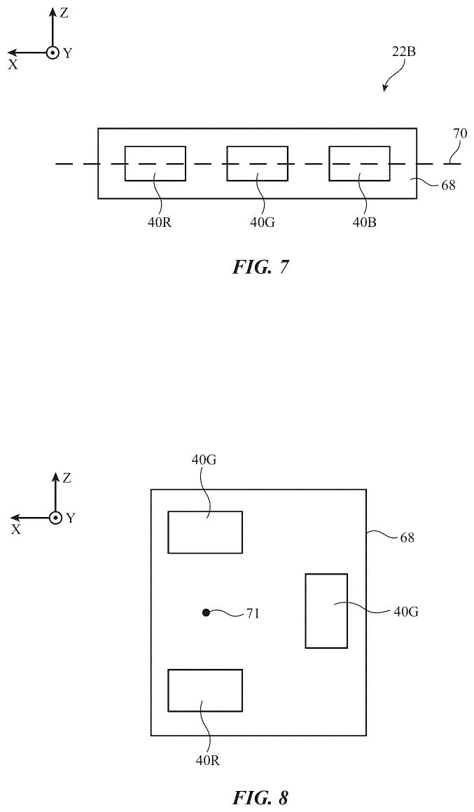

FIGS. 7 and 8 are front views showing examples in which projector 22B includes three display panels 40 that each emit a different respective wavelength range (color) of the image light 38 provided to eye box 20B. As shown in FIG. 7, projector 22B may include a first display panel 40R that emits a first wavelength range of image light 38 (e.g., a red portion of image light 38), a second display panel 40G that emits a second wavelength range of image light 38 (e.g., a green portion of image light 38), and a third display panel 40B that emits a third wavelength range of image light 38 (e.g., a blue portion of image light 38). This is illustrative and, in general, image light 38 may include any desired number of wavelength ranges spanning any desired wavelengths or colors.

In the example of FIG. 7, display panels 40R, 40G, and 40B are arranged in a colinear manner on an underlying substrate 68 (e.g., a printed circuit board or other substrate). As shown in FIG. 7, display panels 40R, 40G, and 40B may each be aligned along a linear axis 70 (e.g., display panels 40R, 40G, and 40B may be colinear with linear axis 70). This is illustrative and non-limiting.

FIG. 8 shows an example in which display panels 40R, 40G, and 40B are arranged in a non-colinear manner on substrate 68. As shown in FIG. 8, display panels 40R, 40G, and 40B may be non-colinear with respect to each other. Display panels 40R, 40G, and 40B may, for example, be arranged in a radial pattern around a central point 71. Radially arranging the display panels (e.g., as shown in FIG. 8) may allow the image light produced by each display panel to exhibit a similar path length in reaching input coupler 30 on waveguide 24B. Linearly arranging the display panels (e.g., as shown in FIG. 7) may help to minimize the vertical thickness of nose bridge portion NB on device 10 (e.g., parallel to the Z-axis).

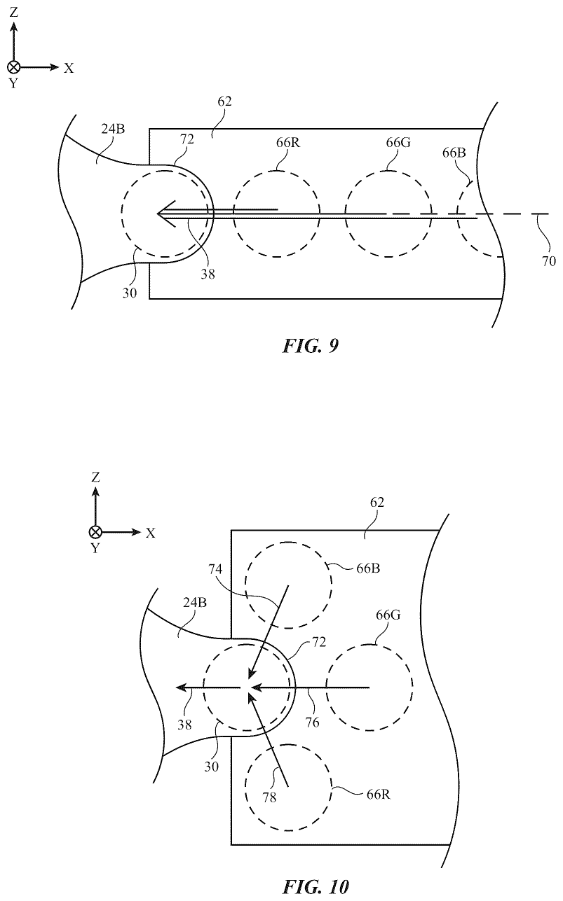

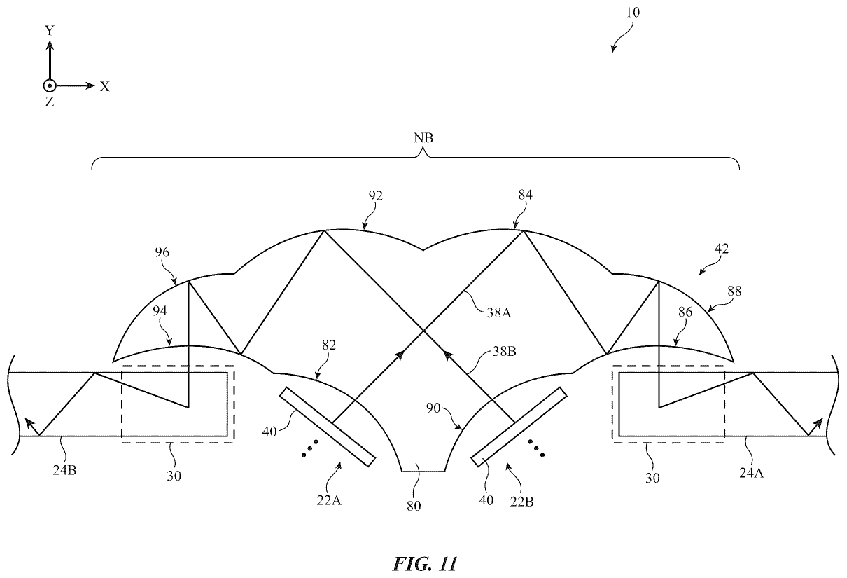

FIGS. 9 and 10 are rear views (e.g., as taken in the direction of arrow 65 of FIG. 6) showing examples in which projector waveguide 62 (FIG. 6) includes three different output couplers 66 that couples a different respective wavelength range (color) of image light 38 out of waveguide 62 and towards input coupler 30 on waveguide 24B. As shown in FIG. 9, waveguide 62 may include a first output coupler 66R that couples a first wavelength range of image light 38 out of waveguide 62 (e.g., a red portion of image light 38), a second output coupler 66G that couples a second wavelength range of image light 38 out of waveguide 62 (e.g., a green portion of image light 38), and a third output coupler 66B that couples a third wavelength range of image light 38 out of waveguide 62 (e.g., a blue portion of image light 38).

Input coupler 30 receives the different wavelength ranges of image light 38 coupled out of waveguide 62 by output couplers 66R, 66G, and 66B and couples the image light into waveguide 24B. If desired, input coupler 30 may be disposed on an extended portion 72 of waveguide 24B (sometimes also referred to herein as protrusion 72, tab 72, or extension 72 of waveguide 24B).

In the example of FIG. 9, output couplers 66R, 66G, and 66B are arranged in a colinear manner on waveguide 62 (or on different respective waveguides in a stack of waveguides 62). As shown in FIG. 9, output couplers 66R, 66G, and 66B may each be aligned along linear axis 70 (e.g., output couplers 66R, 66G, and 66B may be colinear with linear axis 70). This is illustrative and non-limiting.

FIG. 10 shows an example in which output couplers 66R, 66G, and 66B are arranged in a non-colinear manner on waveguide 62. As shown in FIG. 10, output couplers 66R, 66G, and 66B may be non-colinear with respect to each other. Output couplers 66R, 66G, and 66B may, for example, be arranged in a radial pattern around input coupler 30 on waveguide 24B (e.g., aligned with central point 71 of FIG. 8). Output coupler 66R may direct image light of its corresponding wavelength in a first radial direction towards input coupler 30, as shown by arrow 74. Output coupler 66G may direct image light of its corresponding wavelength in a second radial direction towards input coupler 30, as shown by arrow 76. Output coupler 66R may direct image light of its corresponding wavelength in a second radial direction towards input coupler 30, as shown by arrow 78.

Radially arranging output couplers 66 on waveguide 62 (e.g., as shown in FIG. 9) may allow the image light produced by each display panel to exhibit a similar path length in reaching input coupler 30 on waveguide 24B. Linearly arranging the output couplers 66 on waveguide 62 (e.g., as shown in FIG. 10) may help to minimize the vertical thickness of waveguide 62 (e.g., parallel to the Z-axis).

If desired, the optics 42 in nose bridge portion NB of device 10 may include a single prism that redirects image light from the left projector 22B to the left waveguide 24B on device 10 and that redirects image light from the right projector 22A to the right waveguide 22A on device 10. FIG. 11 is a top view showing one example of how optics 42 may include a single prism that directs image light from the left projector 22B to the left waveguide 24B on device 10 and that redirects image light from the right projector 22A to the right waveguide 22A on device 10.

As shown in FIG. 11, optics 42 may include a prism such as prism 80. Prism 80 redirects image light for both the left and right eye boxes of device 10. Prism 80 is sometimes also referred to herein as binocular prism 80, combined binocular prism 80, compound prism 80, folded prism 80, combined prism 80, or freeform prism 80. Prism 80 has multiple refractive surfaces and multiple reflective surfaces that redirecting image light for display at the left and right eye boxes of device 10.

The display panel(s) 40 in projector 22A may emit image light 38A for display at the right eye box 20A of device 10 (FIG. 2). The display panel(s) 40 in projector 22B may emit image light 38B for display at the left eye box 20B of device 10 (FIG. 2). Despite providing image light 38A to the right eye box 20A, the display panel(s) 40 in projector 22A may be laterally interposed between the display panel(s) 40 in projector 22B and waveguide 24B. Similarly, despite providing image light 38B to the left eye box 20B, the display panel(s) 40 in projector 22B may be laterally interposed between the display panel(s) 40 in projector 22A and waveguide 24A.

Prism 80 may have a first surface 82 facing the display panel(s) 40 in projector 22A. Prism 80 may have a second surface 90 facing the display panel(s) 40 in projector 22B. Prism 80 may have a third surface 86 facing the input coupler 30 in waveguide 24A. Prism 80 may have a fourth surface 88 opposite surface 86. Prism 80 may have a fifth surface 94 facing the input coupler 30 in waveguide 24B. Prism 80 may have a sixth surface 96 opposite surface 94. Prism 80 may have a seventh surface 92 opposite surface 82. Prism 80 may have an eighth surface 84 opposite surface 90. Prism 80 may have additional surfaces if desired.

Surfaces 82-96 may each have a different respective curvature (e.g., free form curvatures, spherical curvatures, aspheric curvatures, elliptical curvatures, parabolic curvatures, cylindrical curvatures, etc.). If desired, two or more of surfaces 82-96 may have the same curvature. If desired, one or more of surfaces 82-96 may be provided with a corresponding coating (e.g., a reflective coating, a color filter coating, a polarizer coating, a diffractive grating, etc.). If desired, a scanning mirror (e.g., scanning mirror 48 of FIG. 4) may be optically coupled between prism 80 and waveguide 24B and/or between prism 80 and waveguide 24A.

The display panel(s) 40 in projector 22A may emit image light 38A towards prism 80. Surface 82 may transmit and refract image light 38A into prism 80 and towards surface 84. Surface 84 may reflect image light 38A towards surface 86 (e.g., via TIR and/or via reflection off a reflective coating on surface 84). Surface 86 may reflect image light 38A towards surface 88 (e.g., via TIR and/or via reflection off a reflective coating on surface 86). Surface 88 may reflect image light 38A back towards surface 86 (via TIR and/or via reflection off a reflective coating on surface 88). Surface 86 may transmit image light 38A out of prism 80 and towards the input coupler 30 on waveguide 24A, which couples image light 38A into waveguide 24A for propagation to the right eye box 20A (FIG. 2).

At the same time, the display panel(s) 40 in projector 22B may emit image light 38B towards prism 80. Surface 90 may transmit and refract image light 38B into prism 80 and towards surface 92. Surface 92 may reflect image light 38B towards surface 94 (e.g., via TIR and/or via reflection off a reflective coating on surface 92). Surface 94 may reflect image light 38B towards surface 96 (e.g., via TIR and/or via reflection off a reflective coating on surface 94). Surface 96 may reflect image light 38B back towards surface 94 (via TIR and/or via reflection off a reflective coating on surface 96). Surface 94 may transmit image light 38B out of prism 80 and towards the input coupler 30 on waveguide 24B, which couples image light 38B into waveguide 24B for propagation to the left eye box 20B (FIG. 2).

In this way, prism 80 may perform two transmissions (refractions) and three reflections of both image light 38A and image light 38B. If desired, the curvature(s) of one or more of surfaces 82-96 may be selected to impart a desired amount of non-zero optical power to the image light upon reflection or refraction (e.g., to collimate and/or focus the image light). Prism 80 may have other shapes if desired. Combining the redirection of image light from both projectors 22A and 22B in this way (e.g., using prism 80) may help to further minimize the amount of space required to dispose both projectors in the nose bridge of device 10, while helping to maximize binocular alignment over the operating life of the device.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Devices 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. An electronic device comprising:
a housing having a nose bridge;
a waveguide mounted to the housing;
a display panel in the nose bridge and configured to emit image light;
an input coupler configured to couple the image light into the waveguide;
an output coupler configured to couple the image light out of the waveguide and towards an eye box; and
a scanning mirror configured to reflect the image light from the display panel towards the input coupler.

2. The electronic device of claim 1, wherein the scanning mirror is rotatable between a set of orientations and is configured to direct the image light towards a different respective portion of a field of view of the eye box in each orientation of the set of orientations.

3. The electronic device of claim 1, wherein the scanning mirror comprises a microelectromechanical systems mirror.

4. The electronic device of claim 1, further comprising:
a lens in the nose bridge and configured to transmit the image light from the display panel towards the scanning mirror.

5. The electronic device of claim 4, wherein the waveguide is configured to propagate the image light in a direction via total internal reflection, the lens and the display panel having an optical axis parallel to the direction.

6. The electronic device of claim 1, further comprising:
an additional waveguide mounted to the housing, wherein the nose bridge is between the waveguide and the additional waveguide;
an additional display panel in the nose bridge and configured to emit additional image light;
an additional input coupler configured to couple the additional image light into the additional waveguide;
an additional output coupler configured to couple the additional image light out of the additional waveguide and towards an additional eye box; and
an additional scanning mirror configured to reflect the additional image light from the additional display panel towards the additional display panel.

7. The electronic device of claim 6, wherein the display panel comprises a first array of micro light-emitting diode (uLED) pixels and the additional display comprises a second array of uLED pixels.

8. An electronic device comprising:
a housing having a nose bridge;
a display panel in the nose bridge and configured to emit image light;
a first waveguide in the nose bridge;
a second waveguide overlapping an eye box;
a first input coupler on the first waveguide and configured to couple the image light from the display panel into the first waveguide;
an output coupler on the first waveguide and configured to couple the image light out of the first waveguide and towards the second waveguide; and
a second input coupler on the second waveguide and configured to couple the image light into the second waveguide.

9. The electronic device of claim 8, further comprising:
an additional output coupler on the second waveguide and configured to couple the image light out of the second waveguide and towards the eye box.

10. The electronic device of claim 8, wherein the second waveguide is configured to propagate the image light in a direction via total internal reflection, the electronic device further comprising:
a lens element, wherein the lens element and the display panel have an optical axis orthogonal to the direction.

11. The electronic device of claim 8, wherein the image light comprises red light, green light, and blue light.

12. The electronic device of claim 11, wherein the output coupler is configured to couple the red light, the green light, and the blue light out of the first waveguide.

13. The electronic device of claim 11, wherein the output coupler is configured to couple the red light out of the first waveguide and the electronic device further comprises:
a first additional output coupler on the first waveguide and configured to couple the green light out of the waveguide; and
a second additional output coupler on the first waveguide and configured to couple the blue light out of the waveguide, wherein the output coupler, the first additional output coupler, and the second additional output coupler are colinear.

14. The electronic device of claim 11, wherein the output coupler is configured to couple the red light out of the first waveguide and the electronic device further comprises:
a first additional output coupler on the first waveguide and configured to couple the green light out of the waveguide; and
a second additional output coupler on the first waveguide and configured to couple the blue light out of the waveguide, wherein the output coupler, the first additional output coupler, and the second additional output are arranged in a radial pattern around the second input coupler on the second waveguide.

15. The electronic device of claim 11, wherein the display panel is configured to emit the red light and the electronic device further comprises:
a substrate, the display panel being mounted to the substrate;
a first additional display panel mounted to the substrate and configured to emit the green light; and
a second additional display panel mounted to the display panel and configured to emit the blue light, wherein the display panel, the first additional display panel, and the second additional display panel are colinear.

16. The electronic device of claim 11, wherein the display panel is configured to emit the red light and the electronic device further comprises:
a substrate, the display panel being mounted to the substrate;
a first additional display panel mounted to the substrate and configured to emit the green light; and
a second additional display panel mounted to the display panel and configured to emit the blue light, wherein the display panel, the first additional display panel, and the second additional display panel are arranged in a radial pattern around a central point.

17. The electronic device of claim 8, further comprising:
an additional display panel in the nose bridge and configured to emit additional image light;
a third waveguide in the nose bridge;
a fourth waveguide overlapping an additional eye box;
a third input coupler on the third waveguide and configured to couple the additional image light from the additional display panel into the third waveguide;
an additional output coupler on the third waveguide and configured to couple the additional image light out of the third waveguide and towards the fourth waveguide; and
a fourth input coupler on the fourth waveguide and configured to couple the additional image light into the fourth waveguide.

18. An electronic device comprising:
a first waveguide overlapping a first eye box;
a second waveguide overlapping a second eye box;
a housing having a nose bridge that couples the first waveguide to the second waveguide;
a first display panel in the nose bridge and configured to emit first image light;
a second display panel in the nose bridge and configured second image light;
a first input coupler configured to couple the first image light into the first waveguide;
a second input coupler configured to couple the second image light into the second waveguide; and
a prism configured to direct the first image light from the first display panel to the first input coupler and configured to direct the second image light from the second display panel to the second input coupler.

19. The electronic device of claim 18, wherein the prism comprises:
a first curved surface configured to transmit the first image light from the first display panel;
a second curved surface configured to reflect the first image light after transmission by the first curved surface;
a third curved surface configured to reflect the first image light after reflection by the second curved surface; and
a fourth curved surface configured to reflect the first image light after reflection by the third curved surface, the third curved surface being further configured to transmit the first image light after reflection by the fourth curved surface.

20. The electronic device of claim 19, wherein the prism further comprises:
a fifth curved surface configured to transmit the second image light from the second display panel;
a sixth curved surface configured to reflect the second image light after transmission by the fifth curved surface;
a seventh curved surface configured to reflect the second image light after reflection by the sixth curved surface; and
an eighth curved surface configured to reflect the second image light after reflection by the seventh curved surface, the eighth curved surface being further configured to transmit the second image light after reflection by the seventh curved surface.
